(19) United States
(12) Patent Application Publication
(10) Pub. No.: US 2026/0162475 A1
(43) Pub. Date: Jun. 11, 2026

(54) VEHICLE SYSTEMS WITH INTEGRATED SENSORS AND INTEGRATED ACTUATORS

(71) Applicant: Tesla, Inc., Austin, TX (US)

(72) Inventor: Christian Schotte, Oberkrämer (DE)

(21) Appl. No.: 18/975,984

(22) Filed: Dec. 10, 2024

(51) Int. Cl. G07C 5/08; B60R 16/03; B60S 1/00; G08B 21/18

(52) U.S. Cl. CPC G07C 5/0816; B60R 16/03; B60S 1/00; G08B 21/182

(57) ABSTRACT

The present disclosure seeks to address various technological problems associated with vehicle technology by providing for integration of sensors and actuators in vehicle systems. For example, a wash water pump with an integrated low-level sensor facilitates a wash water reservoir that is solidly constructed with no opening near the bottom. This removes potential failure points where the wash water reservoir may leak, reduces part count, reduces production cycle time, and reduces associated costs. A similar approach with other vehicle systems provides similar technological benefits to vehicle technology.

### TECHNICAL FIELD

The present disclosure generally relates to vehicle components. In particular, the present disclosure relates to vehicle systems with integrated sensors and integrated actuators, including wash water pumps with integrated sensors and integrated actuators.

### BACKGROUND

Wash water reservoirs are common components in vehicles and serve an important role in storing wash fluid that is used, for example, for cleaning windshields on the vehicles. As vehicles become increasingly complex and technologically advanced, even relatively simple components, such as wash water reservoirs, become increasingly complex and technologically advanced. However, as wash water reservoirs become increasingly complex and technologically advanced, they become increasingly prone to failures, such as leaks. Thus, even relatively simple vehicle components, such as water reservoirs, face technological challenges.

### BRIEF DESCRIPTION OF THE DRAWINGS

The figures, which may use like numerals to reference the same or similar elements, depict various examples of the present disclosure for purposes of illustration and are not to be considered as limiting in scope. One skilled in the art will readily recognize that additional example embodiments are possible without departing from the principles of the present disclosure.

FIG. 1 is a diagram of a wash water pump with integrated sensors, according to some examples.

FIG. 2 is a diagram of a wash water reservoir and a wash water pump with integrated sensors, according to some examples.

FIG. 3 is a block diagram of a system with a wash water pump with integrated sensors, according to some examples.

FIG. 4 is a flow chart illustrating a method of manufacturing a wash water pump, according to some examples.

FIG. 5 is a system diagram illustrating an architecture of an electric vehicle (EV), according to some examples.

### DETAILED DESCRIPTION

A wash water reservoir in a vehicle stores liquid used to clean the windshield and, in some cases, the rear window of the vehicle. The wash water reservoir has an opening near the bottom of the reservoir for a fluid level sensor to detect whether the amount of wash water in the reservoir is low. While the fluid level sensor provides useful information, allowing a driver to know when the amount of wash water in the reservoir is low, the opening in the reservoir where the sensor is located causes various technical challenges. For example, the opening is a potential failure point where the reservoir may leak. Indeed, failed seals around the opening where the sensor is installed is a common cause of leaks. Furthermore, as vehicle technology advances and, for example, more electronic systems are introduced to vehicles, the potential damage and safety concerns arising from wash water reservoir leaks rises. Thus, the typical wash water reservoir is prone to leaks, rendering it suboptimal and problematic as vehicle technology advances.

The present disclosure seeks to address the aforementioned technological problems by providing for a wash water pump with an integrated low-level sensor that facilitates a wash water reservoir that is solidly constructed with no openings near the bottom. For example, a wash water pump includes one or more low-level sensors integrated near the bottom of the wash water pump, such as on the inlet (e.g., inlet pipe, inlet conduit) of the wash water pump. With the low-level sensors integrated near the bottom of the wash water pump, the wash water reservoir in which the wash water pump is installed can be constructed with no openings near the bottom. Furthermore, since the low-level sensors are integrated near the bottom of the wash water pump, which in turn reaches near the bottom of the wash water reservoir, the low-level sensors accurately detect whether the amount of wash water in the reservoir is low. In some examples, the wash water pump is extended (e.g., by extending the inlet pipe) so that the low-level sensors integrated thereon are appropriately positioned near the bottom of the wash water reservoir.

Furthermore, the one or more low-level sensors are integrated with the wash water pump such that the wash water pump and the low-level sensors share the same wiring for power and communicating with a vehicle control unit. For example, a wash water pump with one or more integrated low-level sensors uses the same wiring for powering actuators in the wash water pump and for powering the low-level sensors. A voltage switching mechanism allows for both the wash water pump actuators and the low-level sensors to operate using the same wiring. Furthermore, control data transmitted to the actuators is transmitted over the same wiring that transmit sensor data from the low-level sensors. In some examples, a two-wire system allows for power and data to be transmitted to and from the wash water pump and the low-level sensors integrated thereon. With the low-level sensors and the actuators of the wash water pump sharing the same wiring, the wash water pump efficiently reduces the wiring used for power and control of the low-level sensors and the actuators. In some examples, the two-wire system allows for integration of sensors and actuators on various vehicle systems, such as door locks, liftgate power struts, and seat adjusters, reducing the wiring used for these vehicle systems.

In addition to the aforementioned features, the features of the wash water pump with integrated low-level sensors provides various advantages in the field of vehicle technology. For example, in vehicle manufacturing, the wash water pump with integrated low-level sensors reduces part count, reduces production cycle time, and reduces associated costs. Reducing the total number of parts used in vehicle manufacturing provides for more efficient supply chains, simplified inventory management, and reduction in manufacturing complexity. Reducing the total number of parts used in vehicle manufacturing further allows for reduction in production cycle time, which provides for improvements in production output. Furthermore, these improvements reduce associated costs, such as costs associated with sourcing parts, costs associated with maintaining inventory, and costs associated with production time. These improvements are also realized through integration of sensors and actuators in other vehicle systems, such as door locks, liftgate power struts, and seat adjusters. Further details related to the features of the wash water pump with integrated low-level sensors are provided below.

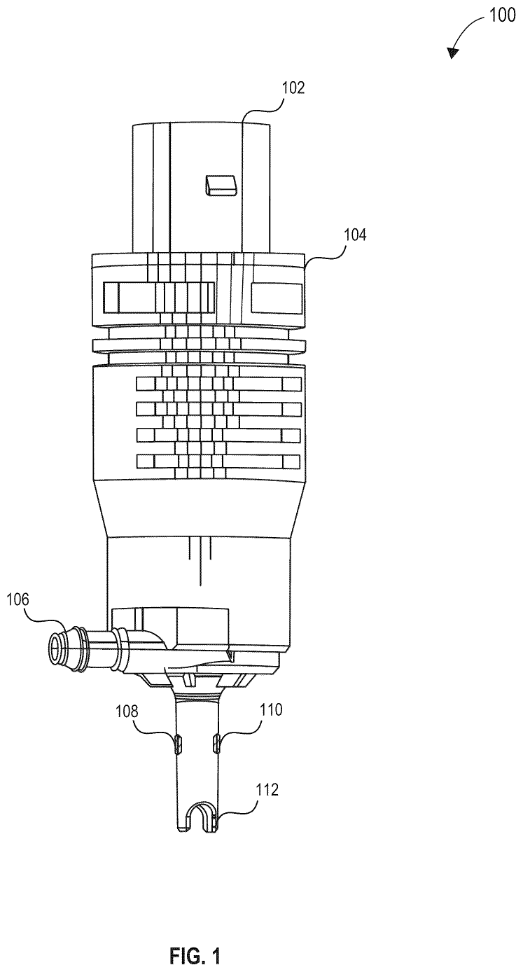

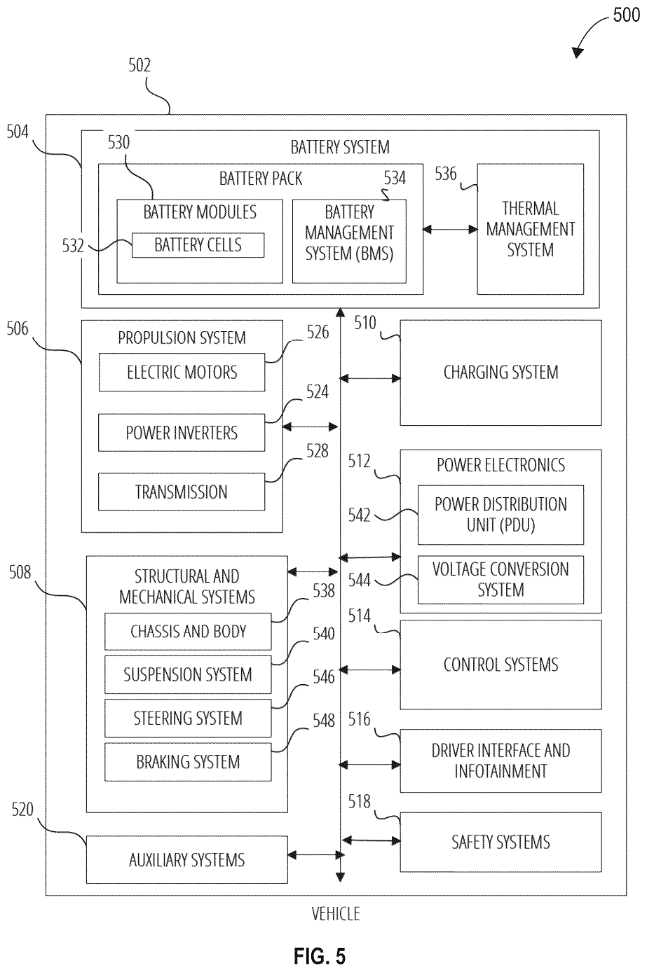

FIG. 1 is a diagram of a wash water pump 100 with integrated sensors, according to some examples. The wash water pump 100 illustrated here can, for example, be included in the vehicle 502 of FIG. 5. As illustrated in FIG. 1, the wash water pump 100 includes integrated low-level sensors 108, 110 on an inlet pipe 112. In some examples, the low-level sensors 108, 110 include conductive probes that facilitate detection of fluid levels in a wash water reservoir through electrical measurement techniques. For example, when the low-level sensors 108, 110 are submerged in wash water stored in the wash water reservoir, the wash water facilitates an electric current between the conductive probes of the low-level sensors 108, 110. The voltage or the resistance between the conductive probes is measured. Based on these electrical measurements, the fluid level of the wash water reservoir is detected. In response to detecting a low fluid level in the wash water reservoir, the low-level sensors 108, 110 can communicate a low fluid level signal to a vehicle controller to generate a low fluid level warning (e.g., low fluid level light on a dashboard). For example, a voltage measured from the conductive probes of the low-level sensors 108, 110 is compared with a voltage threshold. The voltage measured being equal to or above the voltage threshold is indicative of the fluid level of the wash water reservoir being satisfactory (e.g., not low). The voltage measured being less than the voltage threshold is indicative of the fluid level of the wash water reservoir being low. When the voltage measured is less than the voltage threshold, a low fluid level signal is sent by the low-level sensors 108, 110 to a vehicle controller to generate a low fluid level warning.

In some examples, the low-level sensors 108, 110 include a float mechanism that facilitate detection of fluid levels in a wash water reservoir. For example, the float mechanism of the low-level sensors 108, 110 includes a magnetic float that floats on the wash water in the wash water reservoir. As the fluid level of the wash water reservoir drops, the magnetic float descends with the fluid level and draws closer to the low-level sensors 108, 110. When the magnetic float is within a threshold proximity of the low-level sensors 108, 110, an electrical circuit between the magnetic float and the low-level sensors 108, 110 is completed, indicating that the fluid level of the wash water reservoir is low. When the electrical circuit is complete, a low fluid level signal is sent by the low-level sensors 108, 110 to a vehicle controller to generate a low fluid level warning.

The low-level sensors 108, 110 being located on the inlet pipe 112 allows the low-level sensors to accurately detect low fluid levels in the wash water reservoir from within the wash water reservoir. The inlet pipe 112, which serves as the entry point for wash water in the wash water reservoir to flow into the wash water pump 100, extends towards the bottom of the wash water reservoir to draw wash water from the bottom of the wash water reservoir. With the low-level sensors 108, 110 located on the inlet pipe 112, the low-level sensors 108, 110 are located towards the bottom of the wash water reservoir where the low-level sensors 108, 110 can accurately detect low fluid levels in the wash water reservoir. Furthermore, because the inlet pipe 112 is the entry point for the wash water in the wash water reservoir, the low-level sensors 108, 110 located on the inlet pipe 112 can accurately detect low fluid levels with respect to the fluid level at which the inlet pipe 112 can draw wash water from the wash water reservoir.

In some examples, the inlet pipe 112 is extended such that the end of the inlet pipe 112 is near or within a threshold proximity of the bottom of the wash water reservoir. In some examples, the low-level sensors 108, 110 are located at the ends of the inlet pipe 112 such that when the end of the inlet pipe 112 is not submerged in wash water and cannot draw wash water from the wash water reservoir, the low-level sensors 108, 110 are likewise no longer submerged in the wash water and would detect low fluid levels in the wash water reservoir. Thus, the low-level sensors 108, 110 send a low fluid level signal to a vehicle controller to generate a low fluid level warning when the inlet pipe 112 cannot draw wash water from the wash water reservoir. In some examples, the low-level sensors 108, 110 are located at a distance away from, or above, the end of the inlet pipe 112 such that when the low-level sensors 108, 110 are no longer submerged in the wash water and detect low fluid levels in the wash water reservoir, the end of the inlet pipe 112 is still submerged in the wash water and can the wash water from the wash water reservoir. Thus, the low-level sensors 108, 110 send a low fluid level signal to a vehicle controller to generate a low fluid level warning while the inlet pipe 112 can still draw wash water from the wash water reservoir.

As illustrated in FIG. 1, the wash water pump 100 includes an outlet pipe 106 (e.g., outlet, outlet conduit) and a connector 102. The outlet pipe 106 delivers wash water drawn from the wash water reservoir via the inlet pipe 112 to washer nozzles that spray the wash water on a windshield. The connector 102 connects the wash water pump 100 to a wash water reservoir. In some examples, wiring to the wash water pump 100 is connected to the wash water pump at the outlet pipe 106 or at the connector 102. The wiring to the wash water pump 100 delivers power to the internal components of the wash water pump 100, including the pump motor, pump motor control components, and the low-level sensors 108, 110. Data from the low-level sensors 108, 110, including low fluid level signals, are delivered through the wiring to a vehicle controller. In some examples, power to the wash water pump 100 and data from the low-level sensors 108, 110 are delivered through a two-wire system. Power to the wash water pump 100 and the low-level sensors 108, 110 are delivered over the same wiring in the two-wire system.

To accommodate differences in power delivered to the wash water pump 100 and power delivered to the low-level sensors 108, 110, a voltage switching mechanism allows for the wash water pump 100 and the low-level sensors 108, 110 to effectively operate in parallel. To illustrate an example of the voltage switching mechanism, a pump motor in the wash water pump 100 operates at 16V and the low-level sensors 108, 110 operate at 5V. When the wash water pump 100 is not in use and the pump motor is inactive, power to the wash water pump 100 and the low-level sensors 108, 110 is delivered over the same wiring at 5V. The voltage switching mechanism transmits the power to the low-level sensors 108, 110. When the wash water pump 100 is in use (e.g., to deliver wash water), and the pump motor is active, power to the wash water pump 100 and the low-level sensors 108, 110 is delivered at 16V. In this example, power is delivered as a pulse density modulation (PDM) signal that modulates between a high voltage value (e.g., 16V) and a low voltage value (e.g., 5V). The voltage switching mechanism transmits power delivered at the high voltage value to the pump motor, activating the pump motor. The voltage switching mechanism transmits power delivered at the low voltage value to the low-level sensors 108, 110, powering the low-level sensors 108, 110.

The voltage switching mechanism and the pump motor described here are housed in a housing 104 along with other control components and other internal components of the wash water pump 100. With the low-level sensors 108, 110 integrated in the wash water pump 100, functions involving the wash water reservoir (e.g., delivering wash water, detecting low fluid levels) are integrated together into one vehicle component, the wash water pump 100. This provides improved flexibility in design of the wash water reservoir and the wash water pump 100. For example, to fit a narrow vertical space, the wash water reservoir can be shaped as a vertically long rectangular container. The wash water pump 100 can be designed with an elongated inlet pipe 112 or an elongated housing 104 to fit within the wash water reservoir and reach wash water stored at the bottom of the wash water reservoir.

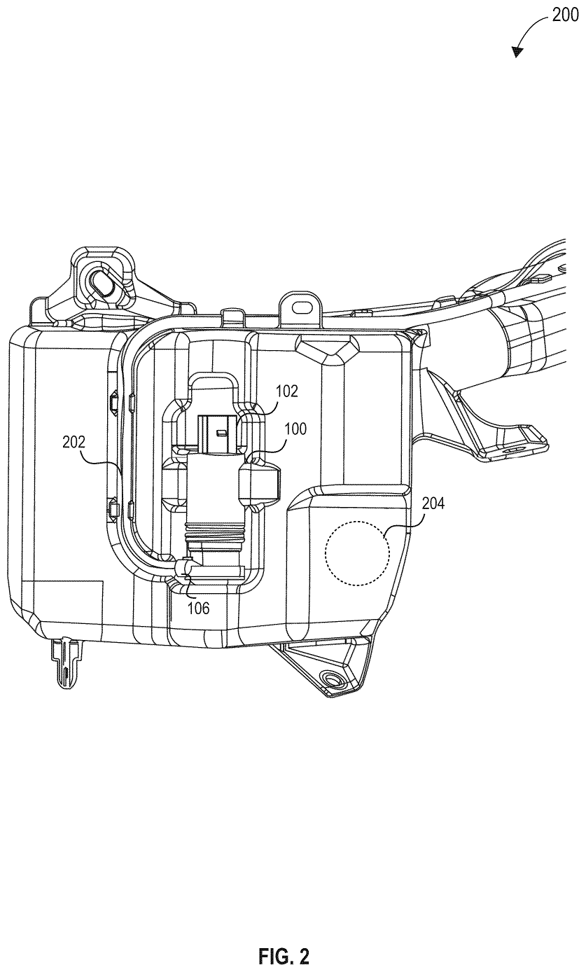

FIG. 2 is a diagram of a wash water reservoir 200 with the wash water pump 100 with integrated sensors, according to some examples. The wash water reservoir 200 with the wash water pump 100 illustrated here can, for example, be included in the vehicle 502 of FIG. 5. As illustrated in FIG. 2, the wash water reservoir 200 generally has a cuboid shape with a central cylindrical channel that houses the wash water pump 100. The wash water reservoir 200 is connected to the wash water pump 100 by the connector 102, which latches the wash water pump 100 to the wash water reservoir 200. The wash water reservoir 200 includes a wash water tube 202 that connects the outlet pipe 106 to, for example, washer nozzles that spray wash water onto a windshield. In some examples, wiring for the wash water pump 100 can connect to the wash water pump 100 through the central cylindrical channel in the wash water reservoir 200 via the connector 102. In some examples, wiring for the wash water pump 100 can connect to the wash water pump 100 along the same channel as the wash water tube 202 via the outlet pipe 106. The wiring, whether it is connected via the connector 102 or the outlet pipe 106, avoids additional openings in the wash water reservoir 200 and improves the resiliency of the wash water reservoir 200 against leaks and other structural failures.

FIG. 2 illustrates a location 204 where an external sensor may be installed in the wash water reservoir 200 to detect low fluid levels in the wash water reservoir 200. Here, the location 204 is near the bottom of the wash water reservoir 200 to detect low fluid levels. Rather than introduce an opening at the location 204 in order to install the external sensor, which compromises the structural integrity of the wash water reservoir 200, the wash water reservoir has solid walls without openings and a solid bottom without openings. With solid walls and a solid bottom, the wash water reservoir 200 avoids any openings where, if a leak occurs, would result in most of the wash water in the wash water reservoir 200 being lost. Thus, as illustrated in this example, the wash water pump 100 with integrated low-level sensors advantageously allows for the low-level sensors to be located near the bottom of the wash water reservoir 200 without introducing an opening that compromises the structural integrity of the wash water reservoir 200.

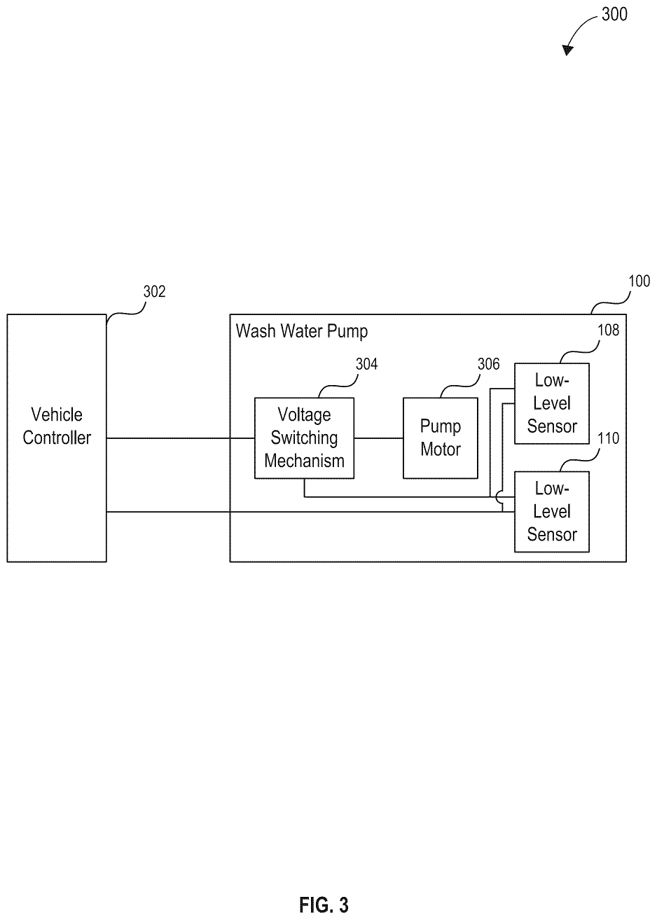

FIG. 3 is a block diagram illustrating a system 300 with the wash water pump 100 with integrated sensors, according to some examples. The system 300 illustrated here can, for example, be included in the vehicle 502 of FIG. 5. As illustrated in FIG. 3, the system 300 includes a vehicle controller 302. The vehicle controller 302 facilitates various vehicle functions, such as windshield washer nozzle operation. The vehicle controller 302 provides various vehicle information, such as low fluid level warnings. The vehicle controller 302 connects to the wash water pump 100 and delivers power to the wash water pump 100 and communicates with the wash water pump 100. Power delivered to the wash water pump 100 is delivered to a voltage switching mechanism 304. The voltage switching mechanism 304 includes, for example, Zener diodes or other switching mechanism to facilitate delivering power to a pump motor 306 when the voltage of the delivered power is above a threshold voltage and delivering power to the low-level sensors 108, 110 when the voltage of the delivered power is below the threshold voltage. For example, the vehicle controller 302 receives an input from a driver to activate the windshield washer nozzles. In response to the input, the vehicle controller 302 delivers power to the wash water pump 100 above a threshold voltage to activate the pump motor 306. Based on the delivered power being above the threshold voltage, the voltage switching mechanism 304 delivers the power to the pump motor 306. Subsequently, the vehicle controller 302 receives an input from the driver to deactivate the windshield washer nozzles. In response to the input, the vehicle controller 302 delivers power to the wash water pump 100 below the threshold voltage to deactivate the pump motor 306. Based on the delivered power being below the threshold voltage, the voltage switching mechanism 304 delivers the power to the low-level sensors 108, 110.

As illustrated in FIG. 3, the low-level sensors 108, 110 deliver sensor information, such as data related to detection of low fluid levels, to the vehicle controller 302. To power the low-level sensors 108, 110 when the pump motor is activated, power is delivered to the wash water pump 100 using a pulse with modulation (PWM) signal. Power to the wash water pump 100 modulates between voltages above the threshold voltage and voltages below the threshold voltage, allowing both the pump motor 306 and the low-level sensors 108, 110 to be powered. As illustrated in this example, the wash water pump 100 with integrated low-level sensors advantageously reduces wiring compared to external sensors for a wash water reservoir.

In some examples, the voltage switching mechanism 304 is adapted for use in various vehicle systems to reduce wiring complexity and component count. For example, in door locks, the voltage switching mechanism 304 delivers power to position sensors that detect if a door is properly closed or open when the voltage of the delivered power is below a threshold voltage (e.g., 5V, 16V) and delivers power to door lock actuators when the voltage of the delivered power is above the threshold voltage. Similarly, for liftgate power struts, seat adjusters, and other vehicle systems, the voltage switching mechanism 304 delivers power to sensors of a vehicle system when the voltage of the delivered power is below a threshold voltage and delivers power to actuators of the vehicle system when the voltage of the delivered power is above the threshold voltage.

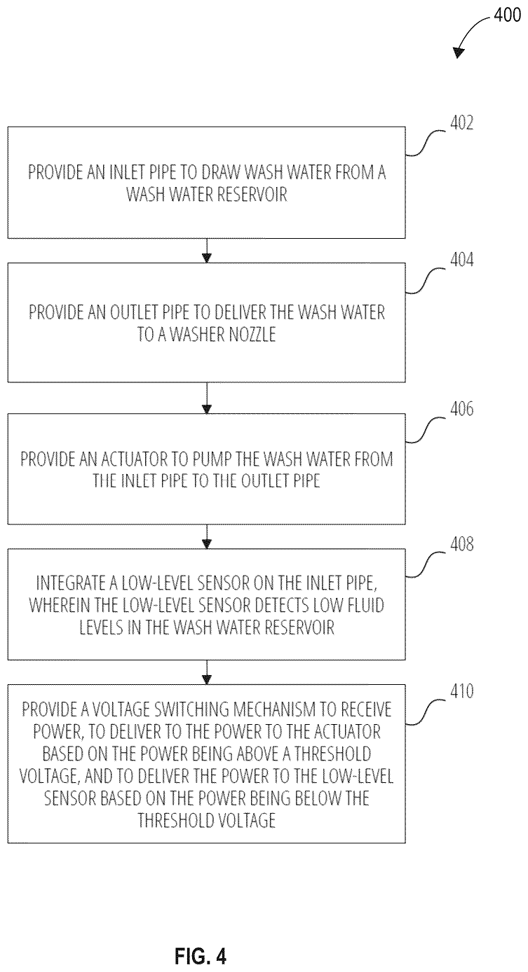

FIG. 4 is a flow chart illustrating a method 400 of manufacturing a wash water pump, according to some examples. The method 400 illustrates example operations that may be performed in manufacturing a vehicle, such as the vehicle 502 of FIG. 5, with a wash water pump with integrated low-level sensors. Although the method 400 depicts a particular sequence of operations, the sequence may be altered without departing from the scope of the present disclosure. For example, some of the operations depicted may be performed in parallel or in a different sequence that does not materially affect the function of the method 400.

At operation 402, the method 400 provides an inlet pipe to draw wash water from a wash water reservoir. At operation 404, the method 400 provides an outlet pipe to deliver the wash water to a washer nozzle. At operation 406, the method 400 provides an actuator to pump the wash water from the inlet pipe to the outlet pipe. At operation 408, the method 400 integrates a low-level sensor on the inlet pipe, wherein the low-level sensor detects low fluid levels in the wash water reservoir. At operation 410, the method 400 provides a voltage switching mechanism to receive power, to deliver to the power to the actuator based on the power being above a threshold voltage, and to deliver the power to the low-level sensor based on the power being below the threshold voltage.

FIG. 5 is a system diagram illustrating an architecture 500 of an electric vehicle (EV) 502, according to some examples. This diagram shows systems and sub-systems that collectively enable the functionality and operational efficiency of the electric vehicle 502.

The vehicle 502 includes a number of higher-level systems which are interconnected, including a battery system 504, a propulsion system 506, structural and mechanical systems 508, a charging system 510, power electronics 512, control systems 514, driver interface and infotainment 516, safety systems 518, and auxiliary systems 520.

The propulsion system 522 includes one or more electric motors 13, which may include traction motors for propulsion and motors for regenerative braking systems, convert electrical energy into mechanical energy. Power inverters 524, facilitate the conversion of DC power from the battery to AC power required by the electric motors 526. The propulsion system also includes a transmission 528, which may consist of a single-speed transmission or gearbox, channeling mechanical power to the vehicle's wheels.

The battery system 504 is composed of several battery modules 530, each housing multiple battery cells 532. These battery cells 532 may be based on various chemistries, including lithium-ion, lithium-polymer, or solid-state materials, each offering distinct advantages in terms of energy density, recharge cycles, and safety profiles.

A battery management system (BMS) 534 continuously monitors various parameters, such as voltage, current, and temperature of each of the battery cells 532 and battery modules 530, to prevent conditions that could lead to overcharging, deep discharging, or thermal runaway. The battery management system (BMS) 534 also manages the state of charge (SoC) and state of health (SoH) of the battery, ensuring that the energy is distributed during discharge and that the charging process is optimized for longevity and safety. Each battery management system (BMS) 534 employs algorithms to balance the charge across the cells and modules, correcting imbalances that can reduce the battery's overall capacity and lifespan.

Integrated with the battery system 504 is a thermal management system 536, which operatively maintains the battery cells 532 within specified temperature ranges. The thermal management system 536 employs temperature sensors to monitor the heat generated by the battery cells 532 during operation. Based on the data collected, it activates cooling and heating mechanisms to regulate the battery's temperature. Cooling methods can include air cooling, where ambient air is circulated around the battery modules, or liquid cooling, where a coolant is circulated through channels in or around the battery modules to absorb and dissipate heat. In colder environments, the thermal management system 536 may employ heating elements or use waste heat from the vehicle's systems to warm the battery cells, ensuring they operate efficiently even in low temperatures.

The charging system 510 operatively replenishes the stored energy within the battery system 504 of the electric vehicle 502. It supports various charging methodologies to ensure flexibility and convenience in energy restoration. The charging system 510 may encompass systems for both standard (Level 1 and Level 2) and fast charging (DC fast charging), facilitating a range of charging speeds to suit different user needs and infrastructure capabilities.

For standard charging, the charging system 510 includes an onboard charger for AC/DC conversion. This onboard charger converts the alternating current (AC) from the electrical grid or home outlets into direct current (DC) that can be stored in the vehicle's battery system 504. The onboard charger may, for example support Level 1 and Level 2 charging, with Level 1 charging using standard household outlets (508-120V) and Level 2 charging requiring a higher voltage source (208-240V), such as those found in dedicated charging stations or installed in residential garages.

For fast charging, the charging system 510 may incorporate a DC fast charging system, designed for rapid energy transfer directly to the vehicle's battery system 504, bypassing the onboard charger. DC fast charging stations supply high-voltage (e.g., 400V to 800V) direct current directly to the battery system 504.

Additionally, the electric vehicle 502 may be equipped with an auxiliary battery, such as a 12V lead-acid or lithium-ion battery may be tasked with powering the vehicle's low-voltage systems, including lighting, infotainment, electronic control units, and other ancillary components, ensuring their operation even when the main battery system is off or during the initial stages of charging when the main system's voltage might be too low for these tasks. This separation of power sources enhances the vehicle's electrical system reliability and ensures the availability of essential functions.

Structural and mechanical systems 508, including a chassis and body 538 and suspension system 540, provide the physical framework and support for the vehicle 502. The chassis and body 538 constitute the vehicle's primary structure, while the suspension system 540, which may include springs, shock absorbers (or dampers), and control arms, to provide a smooth and stable ride by mitigating road shocks and vibrations.

Power electronics 512, including a power distribution unit (PDU) 542 and a voltage conversion system 544, are responsible for the management and conversion of electrical power within the vehicle. The power distribution unit (PDU) 542, equipped with fuses and relays, distributes power to various vehicle systems, while voltage conversion devices of the voltage conversion system 544, such as DC/DC and AC/DC converters, adjust the voltage levels to meet the specific requirements of different components.

Control systems 514 facilitate the driver's command over the vehicle, with a steering system 546 and a braking system 548 as examples. The steering system 546, including a power steering motor, allows for precise directional control, whereas the braking system 548, which may feature disc brakes and an anti-lock braking system (ABS), enables deceleration and stopping.

The driver interface and infotainment 516 supports the driving experience by providing vehicle information and entertainment options through digital displays and multimedia systems. Connectivity features, such as Bluetooth and USB, further augment functionality.

Safety systems 518, designed to protect the vehicle's occupants, may include airbag systems and advanced driver-assistance systems (ADAS), for example. ADAS may use an array of sensors, cameras, radar, LiDAR, and/or ultrasonic devices to monitor the vehicle's surroundings, detect potential hazards, and execute or suggest corrective actions to prevent accidents and mitigate their impact.

ADAS can be categorized into different levels of self-driving capabilities, ranging from Level 0, where the human driver performs all driving tasks, to Level 5, which represents full automation with no human intervention required under any circumstances. Levels 1 and 2 focus on driver assistance and partial automation, respectively, where systems such as adaptive cruise control, lane-keeping assistance, and automatic emergency braking support the driver but do not replace them. Level 3, conditional automation, allows the vehicle to handle all aspects of driving in certain conditions, but requires the driver to be ready to take control when needed. Level 4, high automation, enables the vehicle to operate independently in most scenarios, though human override is still possible.

Examples of ADAS that contribute to these levels of automation include, but are not limited to, adaptive cruise control, which adjusts the vehicle's speed to maintain a safe distance from vehicles ahead; lane departure warning systems, which alert the driver when the vehicle begins to drift out of its lane; and automatic parking systems, which assist or take over control of the vehicle during parking maneuvers. More advanced systems, contributing to higher levels of automation, involve complex algorithms and machine learning capabilities to interpret sensor data, predict actions of other road users, and make real-time driving decisions.

Auxiliary systems 520 support the vehicle's functions and occupant comfort, with climate control and lighting systems as examples. The auxiliary systems 520 may also include windshield wipers etc.

As noted above, the systems of the 502 are communicatively connected. Communications between the interconnected systems within vehicle 502 are facilitated through a vehicle network architecture, employing both hardware and software components to ensure seamless data exchange and coordination. This network architecture may include one or more vehicle communication buses, such as for example Controller Area Network (CAN), Local Interconnect Network (LIN), FlexRay, and Ethernet, which serve as the backbone for intra-vehicle communications.

The Controller Area Network (CAN) bus is a vehicle bus standard designed to allow microcontrollers and devices to communicate with each other within the vehicle 502 without a host computer. Such a network may support control communications between systems such as the battery system 504, propulsion system 506, and control systems 514, due to its high reliability and resistance to interference. A CAN bus may support messages that ensure real-time control and monitoring of these systems.

For other communications, such as those involving the driver interface and infotainment 516 or auxiliary systems 520, a Local Interconnect Network (LIN) bus may be employed. LIN may provide a cost-effective, low-speed serial communication system for connecting intelligent sensors and actuaries. It may serve as a sub-network to the CAN bus, handling signals such as switch inputs and actuator outputs.

FlexRay technology offers a higher data rate compared to CAN and LIN, providing the necessary bandwidth for advanced control systems, including those required for autonomous driving functionalities within safety systems 518. Its deterministic nature and fault tolerance make it suitable for applications that require precise timing and synchronization, such as coordinating the actions of multiple control units in real-time.

Ethernet, with its high data transfer rate, may for example be adopted for diagnostics and infotainment applications within the vehicle 502. It supports the rapid transfer of large volumes of data, making it well suited for advanced driver assistance systems (ADAS), software updates, and multimedia streaming in the driver interface and infotainment 516 system.

Software protocols and application programming interfaces (APIs) built on top of these physical layers enable high-level communication and data exchange between systems. These protocols may define the rules for data format, timing, and error handling, ensuring that messages are correctly interpreted and acted upon by the receiving systems.

Other technical features may be readily apparent to one skilled in the art from the figures, descriptions, and claims herein.

### EXAMPLES

Thus, some embodiments may include one or more of the following examples.

Example 1 is a wash water pump comprising: an inlet configured to draw wash water from a wash water reservoir; an outlet configured to deliver the wash water to a washer nozzle; an actuator configured to pump the wash water from the inlet to the outlet; and a low-level sensor configured to detect low fluid levels in the wash water reservoir.

In Example 2, the subject matter of Example 1 includes, wherein the low-level sensor is located on the inlet.

In Example 3, the subject matter of Examples 1-2 includes, wherein the low-level sensor communicates a low fluid level signal to a vehicle controller.

In Example 4, the subject matter of Examples 1-3 includes a two-wire system to deliver power to the actuator and the low-level sensor and to communicate a low fluid level signal from the low-level sensor.

In Example 5, the subject matter of Examples 1-4 includes a voltage switching mechanism to receive power, to deliver to the power to the actuator based on the power being above a threshold voltage, and to deliver the power to the low-level sensor based on the power being below the threshold voltage.

In Example 6, the subject matter of Example 5 includes a housing to house the voltage switching mechanism and the actuator.

In Example 7, the subject matter of Examples 1-6 includes a connector to connect the wash water pump to the wash water reservoir, wherein the actuator and the low-level sensor share wiring through the connector.

In Example 8, the subject matter of Examples 1-7 includes conductive probes to measures a voltage between conductive probes, wherein the low-level sensor generates a low fluid level signal based on the voltage being below a threshold voltage.

In Example 9, the subject matter of Examples 1-8 includes, wherein the inlet is extended to a bottom of the wash water reservoir.

Example 10 is A wash water system comprising: a wash water reservoir to store wash water; and a wash water pump comprising: an inlet conduit to draw wash water from the wash water reservoir; an outlet conduit to deliver the wash water to a washer nozzle; an actuator to pump the wash water from the inlet pipe to the outlet pipe; and a low-level sensor to detect low fluid levels in the wash water reservoir.

In Example 11, the subject matter of Example 10 includes, wherein the wash water reservoir solid walls without openings and a solid bottom without openings.

In Example 12, the subject matter of Examples 10-11 includes, wherein the wash water reservoir comprises: a central cylindrical channel to house the wash water pump.

In Example 13, the subject matter of Examples 10-12 includes a vehicle controller to deliver power to the actuator and the low-level sensor, wherein the vehicle controller delivers power to the actuator based on an input to activate the washer nozzle.

In Example 14, the subject matter of Examples 10-13 includes a vehicle controller to generate a low fluid level warning in response to a low fluid level signal from the low-level sensor.

In Example 15, the subject matter of Examples 10-14 includes, wherein the wash water pump further comprises: a two-wire system to deliver power to the actuator and the low-level sensor and to communicate a low fluid level signal from the low-level sensor.

In Example 16, the subject matter of Examples 10-15 include, wherein the wash water pump further comprises: a voltage switching mechanism to receive power, to deliver to the power to the actuator based on the power being above a threshold voltage, and to deliver the power to the low-level sensor based on the power being below the threshold voltage.

In Example 17, the subject matter of Examples 10-16 includes, wherein the wash water pump further comprises: a connector to connect the wash water pump to the wash water reservoir, wherein the actuator and the low-level sensor share wiring through the connector.

In Example 18, the subject matter of Examples 10-17 includes, wherein the low-level sensor comprises: conductive probes to measures a voltage between conductive probes, wherein the low-level sensor generates a low fluid level signal based on the voltage being below a threshold voltage.

In Example 19, the subject matter of Examples 10-18 includes a wash water tube to connect the outlet pipe to the washer nozzle.

Example 20 is a method of manufacturing a wash water pump, the method comprising: providing an inlet pipe to draw wash water from a wash water reservoir; providing an outlet pipe to deliver the wash water to a washer nozzle; providing an actuator to pump the wash water from the inlet pipe to the outlet pipe; integrating a low-level sensor on the inlet pipe, wherein the low-level sensor detects low fluid levels in the wash water reservoir; and providing a voltage switching mechanism to receive power, to deliver to the power to the actuator based on the power being above a threshold voltage, and to deliver the power to the low-level sensor based on the power being below the threshold voltage.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all of the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration.

Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially, concurrently, or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

1. A wash water pump coupled to a wash water reservoir, the wash water pump comprising:
an inlet configured to draw wash water from the wash water reservoir;
an outlet configured to deliver the wash water to a washer nozzle;
an actuator configured to pump the wash water from the inlet to the outlet; and
a low-level sensor configured to detect low fluid levels in the wash water reservoir.

2. The wash water pump of claim 1, wherein the low-level sensor is located on the inlet.

3. The wash water pump of claim 1, wherein the low-level sensor communicates a low fluid level signal to a vehicle controller.

4. The wash water pump of claim 1, further comprising:
a two-wire system configured to deliver power to the actuator and the low-level sensor and to communicate a low fluid level signal from the low-level sensor.

5. The wash water pump of claim 1, further comprising:
a voltage switching mechanism to receive power, to deliver to the power to the actuator based on the power being above a threshold voltage, and to deliver the power to the low-level sensor based on the power being below the threshold voltage.

6. The wash water pump of claim 5, further comprising:
a housing configured to house the voltage switching mechanism and the actuator.

7. The wash water pump of claim 1, further comprising:
a connector configured to connect the wash water pump to the wash water reservoir, wherein the actuator and the low-level sensor share wiring through the connector.

8. The wash water pump of claim 1, wherein the low-level sensor comprises:
conductive probes configured to measures a voltage between conductive probes, wherein the low-level sensor generates a low fluid level signal based on the voltage being below a threshold voltage.

9. The wash water pump of claim 1, wherein the inlet is extended to a bottom of the wash water reservoir.

10. A cleaning fluid reservoir system comprising:
a fluid reservoir configured to store cleaning fluid, the fluid reservoir defining an orifice; and
a cleaning fluid pump coupled to the fluid reservoir via the orifice, the cleaning fluid pump comprising:
an inlet conduit configured to draw the cleaning fluid from the fluid reservoir;
an outlet conduit configured to deliver the cleaning fluid to a washer nozzle, wherein the outlet conduit is external to the fluid reservoir when the cleaning fluid pump is coupled to the fluid reservoir via the orifice;
an actuator configured to pump the cleaning fluid from the inlet conduit to the outlet conduit; and
a low-level sensor configured to detect low fluid levels in the fluid reservoir.

11. The cleaning fluid reservoir system of claim 10, wherein the fluid reservoir has solid walls without openings, a solid top with one opening to admit the cleaning fluid to the fluid reservoir, and a solid bottom without openings.

12. The cleaning fluid reservoir system of claim 10, wherein the fluid reservoir comprises:
a central cylindrical channel configured to house the cleaning fluid pump.

13. The cleaning fluid reservoir system of claim 10, further comprising:
a vehicle controller configured to deliver power to the actuator and the low-level sensor, wherein the vehicle controller delivers power to the actuator based on an input to activate the washer nozzle.

14. The cleaning fluid reservoir system of claim 10, further comprising:
a vehicle controller configured to generate a low fluid level warning in response to a low fluid level signal from the low-level sensor.

15. The cleaning fluid reservoir system of claim 10, wherein the cleaning fluid pump further comprises:
a two-wire system configured to deliver power to the actuator and the low-level sensor and to communicate a low fluid level signal from the low-level sensor.

16. The cleaning fluid reservoir system of claim 10, wherein the cleaning fluid pump further comprises:
a voltage switching mechanism configured to receive power, to deliver the power to the actuator based on the power being above a threshold voltage, and to deliver the power to the low-level sensor based on the power being below the threshold voltage; or
a voltage switching mechanism configured to receive power, to deliver the power to the actuator based on the power being below a threshold voltage, and to deliver the power to the low-level sensor based on the power being above the threshold voltage.

17. The cleaning fluid reservoir system of claim 10, wherein the cleaning fluid pump further comprises:
a connector configured to connect the cleaning fluid pump to the fluid reservoir, wherein the actuator and the low-level sensor share wiring through the connector.

18. The cleaning fluid reservoir system of claim 10, wherein the low-level sensor comprises:
conductive probes configured to measures a voltage between the conductive probes, wherein the low-level sensor generates a low fluid level signal based on the voltage being below a threshold voltage.

19. The cleaning fluid reservoir system of claim 10, further comprising:
a wash water tube configured to connect the outlet conduit to the washer nozzle.

20. A method of manufacturing a wash water pump, the method comprising:
providing an inlet pipe to draw wash water from a wash water reservoir;
providing an outlet pipe to deliver the wash water to a washer nozzle;
providing an actuator to pump the wash water from the inlet pipe to the outlet pipe;
integrating a low-level sensor on the inlet pipe, wherein the low-level sensor detects low fluid levels in the wash water reservoir; and
providing a voltage switching mechanism to receive power, to deliver to the power to the actuator based on the power being above a threshold voltage, and to deliver the power to the low-level sensor based on the power being below the threshold voltage.
